(19) United States
(12) Patent Application Publication
(10) Pub. No.: US 2007/0276714 A1
(43) Pub. Date: Nov. 29, 2007

(54) Business process map management

(75) Inventor: Joerg Beringer, Los Altos, CA (US)

Correspondence Address: SAP/BLAKELY, 1279 OAKMEAD PARKWAY, SUNNYVALE, CA, 94085-4040, US

(73) Assignee: SAP AG

(21) Appl. No.: 11/803,751

(22) Filed: May 15, 2007

Related U.S. Application Data
(60) Provisional application No. 60/800,633, filed on May 15, 2006.

(51) Int. Cl. G06F 17/50

(52) U.S. Cl. 705/7

(57) ABSTRACT

Methods and apparatuses enable providing a workflow management environment that provides different workflow management perspectives with different views on a variety of reusable workflow components or workflow resources. The different views may include a swim lane view having multiple separate sections that each represents a different performer, and a list view that represents the resources in transactional order. The workflow management environment defines reusable workflow components and associates the components with the different performers and with each other. The defining of the components and the relationships can define a portion of a workflow.

This U.S. patent application claims priority to U.S. Provisional Patent application No. 60/800,633 filed May 15, 2006.

### FIELD

Embodiments of the invention relate to business process management, and more particularly to management and configuration of a workflow though layout mapping with modular workflow components.

### BACKGROUND

Work within an enterprise or company is frequently performed within the framework of a business process or a workflow having a business objective. The workflow traditionally has multiple phases or states, where a business activity is required for each state. Traditionally, when the business activity has been performed by the user, the workflow can progress to the next phase or state where more business activity will occur. Business systems have been established to generate and manage workflows within the enterprise. A variety of tools are available for establishing and monitoring traditional workflows.

Traditional workflows are ERP (Enterprise Resource Planning)-centric. That is, workflows as previously established were focused around systems. ERP systems were created and put into place, and users were required to think and act around the system in order to accomplish their work. ERP-centric workflow monitoring is most effective when a simple “approve” or “disapprove” is required to “complete” the workflow state. However, many business processes have phases of work that require an “output” or a work product. Such business process phases may be complex in terms of what is required of the user, and yet it will appear within the system as a phase equal to any other within the business process. Thus, a phase for an user to generate a proposal, and a subsequent phase to have a manager approve or disapprove may be considered equal within the system, even though generating the proposal may require much more in terms of business actions to generate.

Current workflow systems create inefficiencies in imposing on users a system to follow that may or may not represent the natural flow of work. Additionally, the individual actions of users and the interactions of users with regard to a phase of the workflow are invisible to the system, which cannot generate tasks or activities to represent such actions, and cannot manage and record the interactions.

Traditional workflow generation tools compound the inefficiencies present in traditional workflows. Workflow generation is traditionally a job for a programming expert that knows the systems, and generates complex workflow statements. Historically, workflows are created by generating a series of “if, then” statements or other system-centric constructs. The workflow development tools have thus traditionally been non-intuitive in that they do not provide tools to represent workflows in the actual manner that people get work done, nor do they generate workflows that represent the actual manner in which work gets done within the enterprise. Furthermore, workflow development has historically been limited by allowing representation only of an activity of a business process, without being able to model or access individual actions within the activity. The resources and the interactions between users implementing the workflow are unavailable from the system level. Furthermore, traditional workflow generation was limited to what was known prior to beginning the work.

### SUMMARY

Methods and apparatuses enable providing a workflow management environment that provides different workflow management perspectives with different views on a variety of reusable workflow components or workflow resources. The different views may include a swim lane view having multiple separate sections that each represents a different performer, and a list view that represents the resources in transactional order. The workflow management environment defines reusable workflow components and associates the components with the different performers and with each other. The defining of the components and the relationships can define a portion of a workflow. The workflow management environment enables modeling workflow from multiple layers, such as business scenario, activity, actions, and resources. Each layer can be separately addressed and then brought together under a business scenario to create a workflow for accomplishing the business goal of the business scenario. The workflow management environment also enables status tracking and incorporation of ad hoc processes into the workflow.

The different reusable workflow components can include actions, resources, and conversations. The resources may include business objects, documents, files, and/or enterprise services. The conversations can represent any human-to-human interaction, including recorded verbal exchanges.

In one embodiment, the workflow management environment is capable of dynamically switching between views, and switching among different resources. Thus, a workflow can be viewed, generated, and/or managed from any of a number of dynamically selectable perspectives.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system with a fixed workflow having a task representing a long-running activity that includes multiple actions.

FIG. 2 is a block diagram of an embodiment of a system for generating workflows from reusable components.

FIG. 3 is a block diagram of an embodiment of a system with a host that provides a resource to a process map designer.

FIG. 4 is a flow diagram of an embodiment of a process for requesting and performing as part of a managed workflow.

FIGS. 5A-5B are block diagrams of an embodiment of a business process development environment for developing a workflow from one of multiple management perspectives.

FIGS. 6A-6B are block diagrams of an embodiment of a business process development environment for developing a workflow from one of multiple management perspectives.

FIG. 7 is a flow diagram of an embodiment of a process for managing a business process.

FIG. 8 is a block diagram of an embodiment of a business scenario modeler.

FIG. 9 is a block diagram of an embodiment of an activity modeler.

FIG. 10 is a block diagram of an embodiment of project status monitoring.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Methods and apparatuses enable generating distributed workflows that couple activities with a business scenario, and relate action to each other with request-to-perform (RTP) relationships. Methods and apparatuses also enable a workflow management environment. The workflow management environment provides different management perspectives that can be used to develop or manage a workflow. Design-time tools enable generation of building block components and workflows. Runtime tools allow dynamic management and ad hoc collaboration within workflows. The workflow management environment enables different views on modular components of a workflow. The modular components are reusable building block components of a workflow. One management perspective of the workflow management environment is that of linking roles or performers to modular components, such as actions, resources, or conversations. The modular components are assigned to a performer and related to other modular components.

The workflow management environment provides tools to create a workflow in a manner consistent with the way in which people do work, providing a layout of the workflow from the perspective of actions, resources, or even conversations that make up a workflow or a portion of a workflow. The modular components are related to one another via relationships that can map their place in the workflow (e.g., one activity is performed prior to another activity, or the occurrence of one input to a conversation leads to another input in the conversation, etc.). The various components of the workflow can be associated together through the management environment, and a workflow created which maps the various actions or sub-portions of a workflow. Various aspects of the workflow can also be represented and monitored with the management environment using the same mapping and relationship tools.

The actions are associated with a business scenario or a business process. The RTP relationships enable management of distributed activities that are part of the workflow. The actions are modeled components, where the model defines the actions in a way the system can manage. The modeled actions define resources related to a business activity. The individual activities can be instantiated and related with RTP relationships to result in a workflow that can be generated and managed by the enterprise system. Interactions between users can be captured within the system as part of the workflow, and represented in the workflow management environment.

As a design-time tool, the workflow management environment allows the framing of human collaboration by business scenario context that has a specific objective and/or trigger. The model does not just allow for actions to be performed, but user-to-user interaction to be modeled and become part of the workflow for the business scenario. In one embodiment, key performers are viewed with swim lanes within a business process map layout, where contributions of each key performer (role) are defined as activity blocks by an individual. Note the contrast of such an approach to the traditional methods of defining a workflow that has different task owners with each phase of the workflow).

Additionally, the workflow management environment introduces RTP relationships as a flexible, ad hoc request and coordination between a requester and a performer to reflect a loosely coupled relationship between the requester and performer. Potential ad hoc coordinations between the requester and performer can become part of the system. With a distributed activity model, workflows are not hard-fixed concepts that do not allow modification or ad hoc processes. Rather, such collaboration or process flow change can become part of the workflow. Each activity is defined at design-time as a rich context bundle with respect to core actions, pre- and/or post-conditions, in/out resources, embedded requests, etc.

The resulting design-time provides a flexible approach with multiple perspectives for different roles (e.g., individual performers, process orchestrator, action (service) enabler, etc.). Additionally, the flexibility can extend to dynamic definition of a workflow. A workflow can be defined in part, or partially through a template, and additional details or complete resources/actions may be included after initial design-time. Workflow can be incrementally defined starting with a partially defined distributed workflow (e.g., missing one or more performers, missing one or more activities, missing a resource). Collaborative definitions allow a performer to model activities based on how work is actually accomplished. Such an ad hoc definition can become a template, or simply part of the individual workflow instantiation.

In one embodiment, the workflow management environment allows formal definition of components, or data mining of completed actions. User actions can be logged in an ESA environment and aggregated across event instances.

The workflow management environment can be considered to be flexible between design-time and runtime. In one embodiment, RTP is pre-defined at design time to define a workflow, it can be included but not defined as a conditional request at design time, and it can also be captured at runtime as an ad hoc variation of the model. Ad hoc variations may be consolidated into the model (e.g., as a template) in one implementation to refine the existing workflow model. The back and forth between runtime and design time, and a simplified visualization of distributed activities with different modeling levels provides a level of workflow design/creation and management not previously available. Different modeling levels may include, for example, scenarios, activities of individual contributors, actions as reusable building blocks, and completion status of building blocks.

The workflow management environment or process map designer or various modelers described herein can be considered “consumer” of one or more data models that provide components used to generate workflows, business scenarios, activities, etc. In one embodiment, the data model and workflow infrastructure with which the designers and modelers operate is a distributed activity model as described in co-pending U.S. patent application Ser. No. TBD, entitled, “Distributed Activity Management,” filed concurrently herewith. Other data models could be used. More details follow with regards to terminology and understanding of distributed workflows, and the generation and runtime of distributed workflows.

Traditional transactional applications and ERP-centric workflow models are not technologically equipped to support enterprise services architecture (ESA) or multi-channel, multi-modal occasionally connected (OCA) user experience. Traditional workflow only works for very simple tasks such as: “provide an approval,” after which the system can continue to execute the workflow. When tasks are more complex, which is increasingly common, the additional actions a user performs to “complete” the task are not traditionally part of the workflow model.

With ESA, business applications are closer to a bundle of resources than a monolithic transaction or application. Thus, workflow that focuses on transactions rather than services and resources results in inefficiencies. In contrast to traditional monolithic transaction-based workflows, enterprise services can be composed into granular user actions that serve as reusable building blocks when modeling activities within a distributed workflow. Rather than writing an application, the developer generates short process descriptions and attaches available services and business actions to the process description. An activity within the distributed workflow model is created by assembling actions together. Workflow can be represented by any of the reusable building blocks, such as the actions, resources (documents, services, etc.), or the interactions between people).

In one embodiment, the distributed activity management can be considered to have two components: a service-oriented Activity Model that defines a relationship of an activity to a business scenario; and, an Event Model that defines an RTP relationship between activities. The Activity Model allows actions to be generated as components or building blocks that can define individual actions or operations that will be performed by a user in context of one activity. The activity can have an extended context describing typical performers, pre-conditions, required resources, core actions, related information, related resources, accept and declare options, business rules, task classification, etc., which can be dynamically assigned to an individual action and related to the business scenario. The distributed Activity Model describes business processes by means of definitions or descriptions that couple activity-centric contexts that are connected to a Scenario that serves a specific business intent. The Event Model defines events as requests-to-perform (RTPs). In one embodiment, the Event Model includes annotations (e.g., metadata) that identify a work Requester and a work Performer in any transaction. The Event Model further supports ad-hoc conversations and acceptance terms among the Requester and Performer. Both are captured in the workflow management environment.

The Event Model further supports ad-hoc conversations and acceptance terms among the Requester and Performer. That is, collaboration between the Requester and Performer can become part of the model from which workflows are created. The Event Model allows building an ad hoc coordination between the requester and the performer. The ad hoc coordination can reduce the complexity of flow models while still allowing for typical ad hoc conditions of state transition in the workflow based on negotiation between the requester and performer. Thus, state transitions can occur and ownership of activities can transfer within a workflow due to negotiation or other collaboration between requester and performer. The RTP relationship can thus be ad hoc, allowing dynamic activity to be modeled within the system.

By modeling business processes as a collection of loosely coupled individual contributions of individuals, the control structure of the distributed workflow more closely resembles the actual work practice of enterprise users. Such is depicted in the representations of the management environment. In one embodiment, business workflow and person-to-person work procedures are brought together, seeing that the same data model and technology can be used to model fixed workflows (business workflow) as well as distributed workflows by modifying the requester-performer relationship and the conditional actions. The same technology can also be used to handle system or human requests. The same technology can also be used to model simple activities consisting of a single task or complex activities consisting of tasks including sub-activities. Distributed workflows could also be integrated with traditional fixed workflows.

Additionally, distributed workflows allow contextual collaboration in person-to-person work processes. Solutions for human activities can be provided as enterprise solutions to support more flexible and ad-hoc human activities. Procedures that are currently “hidden” within an enterprise could be surfaced and streamlined, and checked for compliance and efficiency. Including people processes into business processes enables the handling of exceptions and less structured work at a system level. Such procedures are “visible” in development through the workflow management environment, and visible to the system in that assignments are made that allow the procedures to be created on a system level and monitored.

Thus, distributed activity management provides a model-driven workflow using a request-perform control structure that puts distributed collaborative activities into a coherent context related to a business goal. The distributed activity model describes business processes by means of loosely coupled activity-centric context models, and connects such models to scenarios that serve a specific business intent.

According to the teachings herein, an enterprise system can model a business process on multiple layers. In one embodiment, a business process is modeled on three layers: Scenario, Activity (task), and Action. A scenario layer exists on a first level, where a developer lays out the activities of users, and connects activities of one or several users through an event-driven control flow, such as RTP relationships. Thus, in one embodiment, every activity has a requester and a performer. Requests can be simply accepted and acted on, or the performer can ask for additional details or enter negotiations with the requester. The scenario description may include a role description for the performer of an activity that profiles the performer with respect to skills, organizational role, relationships to other performers, or simply the name of the user. The role definition facilitates the scenario and a resulting business process to be dynamic. Rather than inputting a particular person into the business process, the business process can be defined in terms of a role, or a “type” of person that can/should perform a particular action. When the business process is instantiated, the system can place an actual person into the workflow.

Scenarios are composed by defining activity blocks, assigning them to process roles, and linking them through requests. Each activity is triggered by a request, which may be either a system event or human request. Resources from the scenario context are handed over to activities as required resources. As used herein, resources refer to elements that may be used to perform a work action. Examples may include a business object (a vendor, an invoice), a document (a statement of work (SOW)), an interactive form (ISO certification questionnaire), people, a report, etc. Ad-hoc conversations between requester and performer are supported and optionally captured as a conversation thread.

An Activity Model within a scenario is modeled as a separate entity describing an actionable business context interfacing with the scenario via events. A request event triggers an activity that models personal contributions in the form of a context description that defines potential actions, resources, rules, and related information associated with the activity. The activity may also include requests to other contributors to perform certain activities. An activity can further be split into separate actions that accomplish a task. As used herein, a task refers to a phase of a workflow. A task is some work or action (which could be an Action as described below), or something to do or accomplish. Tasks may be the subject of requests. An activity block is a collection of actions, information, and related resources that one user needs to accomplish the requested task. Each activity block may provide guidance for individual performers in terms of what actions to perform, and the checking of preconditions, required resources, and business rules. Each activity can be enriched to offer related information and actions. The system can also model activities recursively, so that a request within one activity can trigger sub-activities or entire new work situations (scenarios).

An Action is a reusable atomic building block for meaningful business acts. An action provides a high-level enterprise service that encapsulates services and a user interface (UI). In one embodiment, actions provide a plug-and-execute interface to the activity context. In one embodiment, an action is a non-transactional view of a work item. Actions can provide the UI for supporting user interaction. Actions as reusable building blocks can be used to construct complex activities of a distributed workflow. Actions are connected to the enterprise backend (ESA), and may contain embedded navigation (e.g., object links, multiple screens such as guided activities). Examples of actions might be: Post Message, Create PO, Approve Vendor, View Supplier Details, View 360 supplier review, Create Vendor Record, Request Missing Document, Choose Between Candidates, Evaluate Candidate, Submit Application, Set New Salary, Promote Employee, Create Invoice, etc., or anything that can be perceived as an atomic work action from a business perspective or atomic enterprise business work activity. Thus, actions will likely be different in different implementations, seeing that different enterprises/organizations may view the atomic level of actions differently.

To capture, generate, and execute distributed workflows, the enterprise system includes design-time and runtime components. Details of each are described below. Regarding design-time components, simplified design times enable business experts to model scenarios and activities. Scenarios that already exist within an enterprise can serve as templates for new processes. Reusable actions enable business experts to configure an activity without implementing any service or UI. The design-time components are embodied in a design-time engine, which may include separate components (e.g., separate modules), or may include the functionality of each of the below. In one embodiment, a Process Map diagram tool or function is used to lay out processes.

The Process Map diagram is an example of the workflow management environment as discussed herein. Such a process map diagram lays out roles across “swim lanes,” and displays activities and their associated requests along those swim lanes. The swim lane provides a simple mechanism for orchestrating the activities of multiple performers, and then converting them by the system into a distributed workflow model. To include system generated event and activities, a swim lane can also represent services or business objects that are controlled by system applications and workflows.

In one embodiment, the design-time engine includes or embodies an Activity Composer, which can be used to compose all actions required to accomplish an activity. Activities and actions can be enriched with contextual information. The Process Map can be used to link activities from several people via RTP events. The Activity Composer can be used to model individual activities. This clear distinction helps business experts to focus on either the process scenario level or the personal task flow level. The Activity Composer allows a designer to pull together specific services into the activity to enable a user to perform actions via the services.

In one embodiment, the design-time engine includes or embodies an Activity Broker that determine whether a particular action can be displayed/accessed via a particular device, and if so, in what mode. The Activity Broker can enable support for multi-channel and OCA runtimes. The information about modes and channels can be provided directly in the activity through metadata or activity parameters.

In one embodiment, activities and actions are annotated. For example, activities can be annotated with respect to task complexity on a scale from problem solving to simple approval. Actions can be annotated with respect to UI requirements such as needs a large (relatively) display or, can be done via voice. Actions can also be annotated with respect to availability of service, for example, real-time, offline, OCA. Together with personal preferences these annotations allow for smart dispatching, previewing, and execution of activities in multiple devices. Such annotations can exist via metadata associated with the activity and/or action. Such annotations can also be accessible via the Process Map layout.

Regarding the runtime components, the runtime can be generally considered to be provided by a runtime engine, which includes various components (e.g., modules) or embodies the functionality. The runtime provides progressive access to business context and functions of the distributed workflow. Requests can be managed on any device. Users (workers) can preview activities by checking the existence of required resources, and the fulfillment state of pre-conditions. The users can preview their own activities by looking into the list of modeled actions of an activity. The execution of one of those actions, or the viewing of resources and related information depends on the device capabilities and the match of task complexity to current mental load of the user. The current mental load of the user can be inferred or derived by context-awareness based on device, location, and work situation.

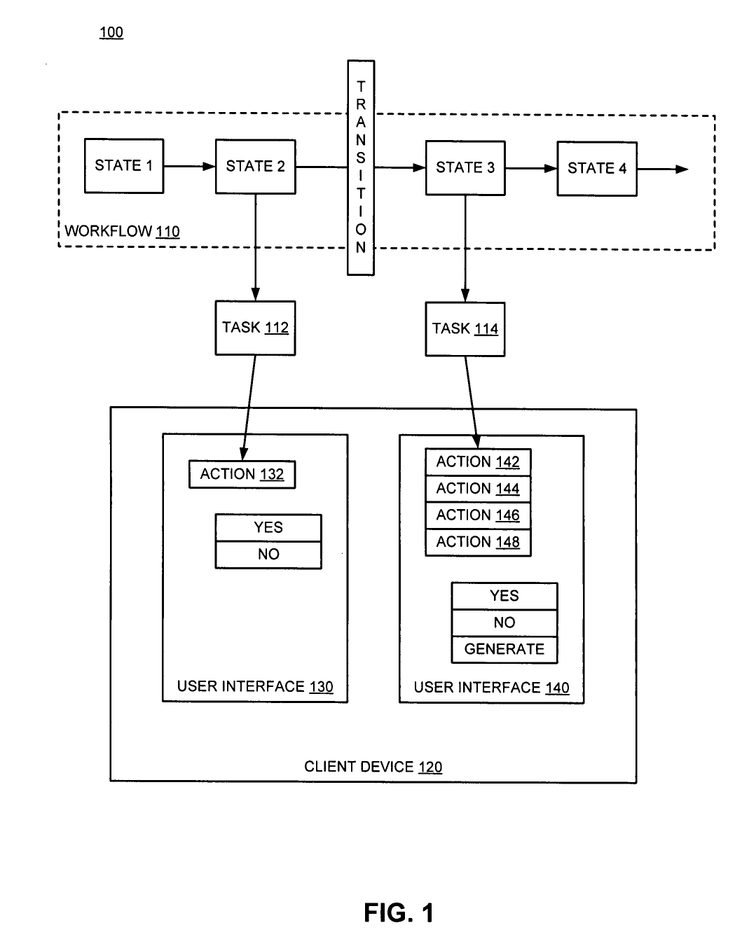

FIG. 1 is a block diagram of an embodiment of a system with a fixed workflow having a task representing a long-running activity that includes multiple actions. System 100 represents an enterprise system that includes client device 120, and workflow 110. Workflow 110 is an application or an enterprise system control structure that is typically executed from a backend enterprise system. One or more components of workflow 110 could be executed locally on client device 120; however, workflow 110 will generally be considered to be executing on a system level via business logic and enterprise services available from the backend system.

In one embodiment, workflow 110 represents a fixed or transactional workflow, which is a workflow that is defined as a whole system, and states or phases of the workflow are generated to fill out the system. Contrast such a top-down approach with the more bottom-up definition of a distributed workflow as described herein, where multiple activities are defined, and are then coupled together in a workflow for a business scenario. Workflow 110 includes states 1-4, which represent different transactions of the workflow. Each state can be simple, such as “provide approval for the budget,” to something more complex, such as, “interview top candidates.” Note that four states are shown for purposes of simplicity, and it is possible, and may be common, for workflows to have many more phases.

Consider the transition illustrated between state 2 and state 3. Similar transitions occur between all states, and only the transition between states 2 and 3 is shown. Specifically, in a fixed workflow, the transition is controlled via a transaction model where a user completes the “transaction” required for the particular state, and may provide information to the system for the state. Once the state is completed, the user can so indicate the completion to the system, which then allows the states to transition. In such a control model, interactions between users is typically not part of the system model and control, nor can “ownership” or responsibility for a particular state change according to different actions that need to occur to complete the transaction.

As illustrated, state 2 is represented by task 112, which is a business activity or some work that needs to be accomplished, or some business action or group of actions that needs to be performed towards the final achievement of completing the business process represented by workflow 110. Similarly, task 114 represents the business activity of state 3. In one embodiment, task 112 is a simple task that may have only a single action, action 132, which needs to be performed to complete the task. In contrast, task 114 is a complex task or a long-running activity that has multiple actions, actions 142-148, which need to be accomplished to complete task 114. For example, task 112 and consequently action 132 can be completed with a simple yes or no as illustrated in user interface 130. In contrast, task 114 requires the completion of actions 142-148 that may not only involve one or more yeses or nos, but also a “generate,” which requires producing something for the business process (e.g., a document, a report, etc.). Hence, task 114 is referred to as a long-running activity due to the multiple actions required to complete the task.

Note that task 112 is represented in user interface (UI) 130, and task 114 is represented in UI 140. In practice, UI 130 and UI 140 may be the same user interface. They may alternatively be components of the same interface (e.g., windows, panes, fields, etc.). Alternatively, they may be separate interfaces, each rendered separately. In one embodiment, task 114 is not displayed until task 112 is completed. Task 112 and task 114 may also be the responsibility of different users, which would mean that different users would receive the UIs 130 and 140.

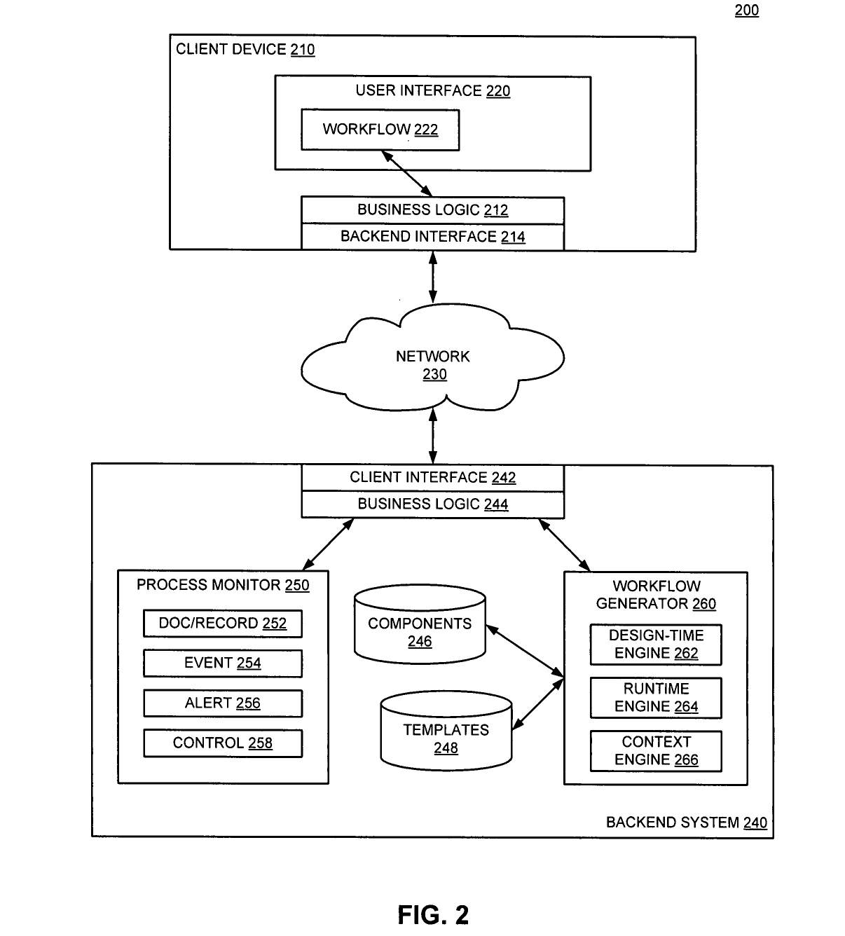

FIG. 2 is a block diagram of an embodiment of a system for generating workflows from reusable components. System 200 includes client device 210 and backend system 240. Client device 210 represents any of a number of devices with which a user may interface with a workflow. Examples include, but are not limited to, desktop computers, laptop computers, mobile phones, handheld wireless devices, etc. Client device 210 includes user interface 220, which represents one or more input and output components that enable a user to interact with an item represented in the UI. UI components may include touchscreens, displays, keypads, etc. In one embodiment, UI 220 is able to represent workflows, such as workflow 222 within system 200. Note that system 200 may support both fixed and distributed workflows. As mentioned above, workflows that are traditionally fixed can be generated with the same technology used to generate distributed workflows. Additionally, distributed workflows can be generated which model business processes not previously available in enterprise systems.

Workflow 222 is a representation of a bundle of enterprise resources, such as document or business object resources, as well as enterprise services that enable access to backend functionality and enterprise business objects. In one embodiment, at least a portion of the functionality presented via distributed workflow 222 is enabled via business logic on the enterprise system (business logic 244). Additionally, client device 210 may include business logic 212 that provides connection functionality and enables use of the services from client device 210. In one embodiment, business logic 212 represents runtime components that may be executed from client device 210. Other runtime components are executed in backend system 240, and may be represented by business logic 244.

Client device 210 includes backend interface 214, which may be a general-purpose network connection device, such as a network interface card, a wireless (e.g., WLAN) or cellular circuit, etc. Backend interface 214 connects to backend system 240 via network 230, which represents any type of network or combination of networks. For example, network 230 may be a wired local area network (LAN), a wireless LAN (WLAN), a cellular communications system, etc. Backend system 240 is coupled to network 230 via client interface 242, which enables backend system 240 to interface with client devices including sending and receiving information related to workflows.

Backend system 240 represents one or more enterprise servers, databases, etc. In one embodiment, backend system 240 includes process monitor 250, which represents one or more modules or components that manage workflows. Process monitor 250 may include, for example, modules for generating or storing a document or record 252, for producing an event 254, for generating a system alert 256, and for generating a system control 258. Record 252 represents any type of system storage of a task. The storage may be in the form of data in a field of a database, a document, a file, etc. Event 254 represents system operations that may take place as a result of work on a workflow activity. Events may include anything from scheduling to shipping to generating a task for another user. Alert 256 represents a mechanism within backend system 240 that can provide information to one or more users regarding a workflow or an action of a workflow. Alerts can be produced on a schedule (e.g., daily, weekly), as well as occurring when an action occurs, when a state change happens, etc. Control 258 represents any other type of control, system signal, command, error, etc., which may be generated by backend system 240 via process monitor 250 in response to something happening or not happening (that should be happening) on a workflow.

Backend system 240 also includes workflow generator 260, which represents components that generate workflows. Workflows as described herein include various aspects—design-time components include templates and building blocks that represent the workflow and its constituent elements (e.g., actions, resources, etc.); runtime components include instantiated versions of the templates and building blocks in a workflow for execution; and, distributed workflows as described herein include context, which relates to a business scenario to which the workflow components are related. Components 246 represent the building block components used to generate a workflow, such as actions. Templates 248 represent other building blocks, and may include associations or relationships that relate one or more actions or activities to a context. In one embodiment, templates 248 cannot exist without context; thus, templates 248 can be considered to include context that defines relationships between components 246.

Design-time engine 262 represents one or more modules that enable generation of a workflow and/or its constituent elements. In one embodiment, design-time engine 262 includes modules necessary to provide a development environment in which a developer can generate actions, activities, context (business process or scenario) descriptions, templates, relationships (which may include RTP relationships), resource associations, etc., which are considered the constituent elements of a workflow. Once developed or generated, these elements can be stored in one or more databases, represented as components 246 and templates 248, which are available to instantiate a workflow. In one embodiment, design-time engine 262 includes a workflow management environment as described herein. Thus, design-time engine 262 can lay out process components according to the flow of business, linking actions, resources, and people to a business scenario to generate or manage a workflow. Conversations or interactions can be provided as part of a design of a business process or as part of a management of a running process.

Runtime engine 264 represents one or more modules that enable runtime generation of a workflow. Note that certain templates or components as defined in design-time may be defined based on a business role, rather than based on a specific person. At runtime, the system resolves such dynamic variables and assigns actual values to the dynamic template or generic values of the templates. Runtime engine 264 enables the system to create a workflow specific to a given situation or function, referred to as a business context. Runtime engine 264 either includes context engine 266 or works in conjunction with context engine 266 to determine the context of a workflow to be generated. Context engine 266 can determine the context via annotations such as metadata or system-level descriptions, or from other sources. In one embodiment, the context is determined from an input, such as a request, a document, etc. Runtime engine 264 may be enabled by business logic 244 of backend system 240 and/or via business logic 212 of client device 210. Thus, business logic may include elements of a runtime engine necessary to receive workflow components and render them as a workflow.

Various components described herein may be a means for performing the functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a machine readable medium, which provides content that represents instructions that can be executed. The content may result in a machine performing various functions/operations described herein. A machine readable medium includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A machine readable medium may also include a storage or database from which content can be downloaded. A machine readable medium may also include a device or product having content stored thereon at a time of sale or delivery. Thus, delivering a device with stored content, or offering content for download over a communication medium may be understood as providing an article of manufacture with such content described herein.

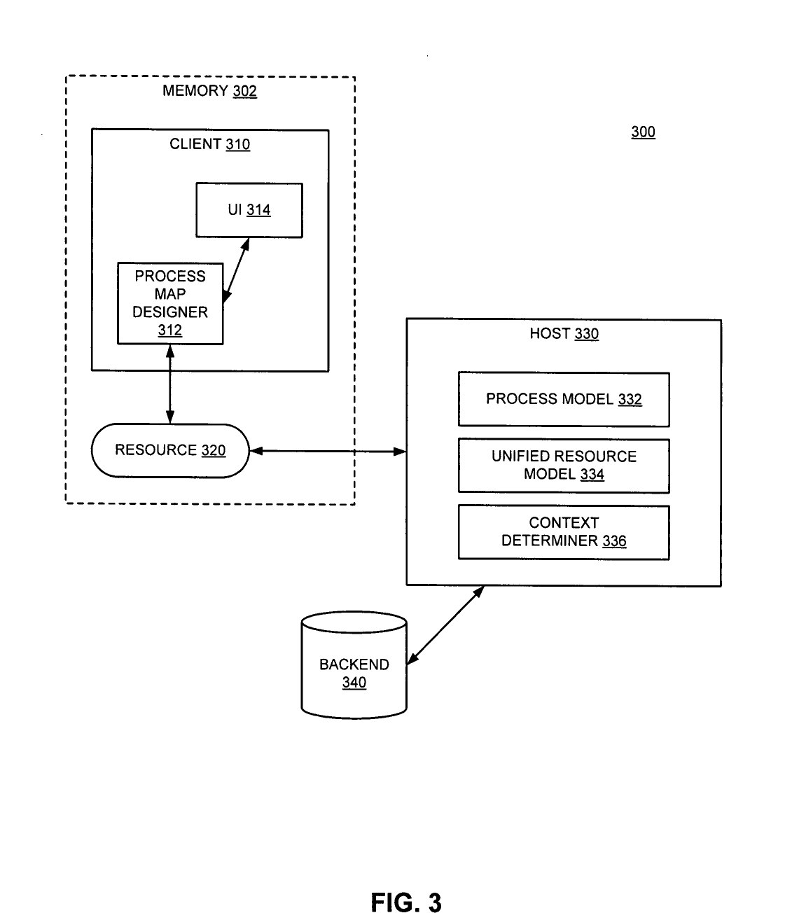

FIG. 3 is a block diagram of an embodiment of a system with a host that provides a resource to a process map designer. Client 310 represents an application or a program that provides workflow access to a user (e.g., a user, a manager). In one embodiment, client 310 is a workflow development application, which includes process map designer 312. Process map designer 312 is an example of a workflow management environment. As discussed above, process map designer 312 provides views of the component parts of a workflow from any of a variety of management perspectives, as described in more detail below. Process map designer 312 will generally exist within a memory in which client 310 is being executed. Memory 302 represents such a memory device, and could be local to a user device, or part of the enterprise system (backend). In one embodiment, process map designer 312 includes a presentation component that renders or presents process map layouts in user interface (UI) 314. UI 314 represents any type of graphical user interface that can present the workflow layout and development environment.

Resource 320 represents any of a number of workflow building block components that can be accessed and provided to a layout in process map designer 312. Resource 320 can be loaded into memory 302 where it is accessible to client 310. Resource 320 may be an action, which includes any of a number of atomic business acts, such as those provided above. Resource 320 may also be any type of workflow resource, such as a document, a file, an enterprise service, a business object, etc. Resource 320 may also be a conversation component, or an input or contribution to a human-to-human interaction that occurs within the context of fulfilling an activity of a workflow.

Resource 320 is provided by host 330, and may be accessed from backend 340. Host 330 represents a workflow infrastructure within an enterprise that can provide process model 332, unified resource model 334, and context determiner 336. In one embodiment, host 330 is an enterprise server with an infrastructure as part of the server. Process model 332 is the model as described herein that enables the generation of resources and the linking or associating of those resources with a performer, with a business process, and/or with another resource. Thus, resource 320 can be provided from host 330 as an element of process model 332, for generating a workflow. Process model 332 provides the structure or framework for generating and managing distributed workflows as described herein. Process model 332 can define layout, association/relationship parameters, etc.

Unified resource model 334 defines a framework for accessing and using resources in a workflow. Thus, unified resource model 334 may define standard access interfaces for resources, access and/or association interfaces, modality compatibility, interface requirements, etc. Unified resource model 334 allows resources of different types and different requirements be incorporated into a workflow in a standard way. Thus, resource 320 can be accessed and incorporated in a standard way into a workflow with process map designer 312.

Context determiner 336 represents one or more modules that obtain or provide context information. The context in the case of distributed workflows is generally the business scenario to which the resource is associated. Context determiner 336 can determine the context by accessing metadata about a business process or business scenario, or metadata about a system or application from which a business process is requested. Context determiner 336 may also identify the context of access of the workflow, for example, from a remotely-connected laptop computer, from a handheld device, from a desktop computer, etc. Context determiner 336 can identify the business scenario to process map designer 312, for example, through providing a context file.

Backend 340 represents backend resources that are accessible in the enterprise. Backend 340 may include one or (commonly) many databases from which documents, data objects, enterprise services, etc., are available. In one embodiment, host 330 accesses backend 340 to obtain resource 320, or to determine context. Backend 340 may include non-volatile storage that stores code for executing client 310 and process map designer 312.

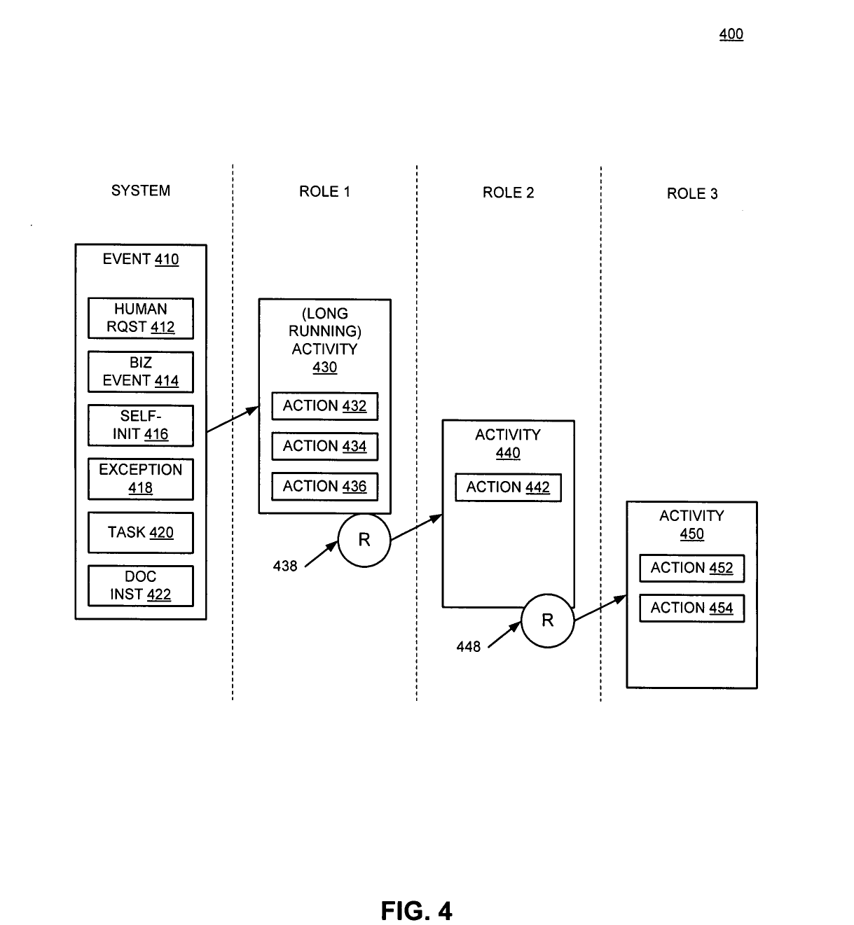

FIG. 4 is a flow diagram of an embodiment of a process for requesting and performing as part of a managed workflow. Flow diagrams as illustrated herein provide examples of sequences of various process actions. Although shown in a particular sequence or order, unless otherwise specified, the order of the actions can be modified. Thus, the illustrated implementations should be understood only as examples, and the process can be performed in a different order, and some actions may be performed in parallel. Additionally, one or more actions can be omitted in various embodiments of the invention; thus, not all actions are required in every implementation. Other process flows are possible.

System 400 includes the “system,” which represents the backend enterprise system, and Roles 1-3, which represent performers and requesters. System 400 is represented as a swim lane view that can enable a developer to associate actions with performers, and relate activities via requests. The Roles can be any type of business role, such as manager, purchaser, lead engineer, system architect, etc. With the process flow of system 400 represented in terms of “Role” actors, the resulting process flow can be generic and useful for any of a number of business scenarios, where Roles and actions are variable in a template, and specific when instantiated. Thus, Roles 1-3 may be any of a number of people in any of a number of business scenarios.

System 400 represents an enterprise system according to any embodiment described herein. Specifically in system 400, a process map layout illustrates events and activities related to roles and to other activities. Event 410 represents an event that triggers an interaction. Although shown as belonging to “System,” events can originate from people as well as the system. Examples of events include human request 412, business (biz) event 414, self-initiated event 416, exception 418, task 420, and document instantiation (doc inst) 422. Each illustrated event is intended to be understood in a broad sense, viewed categorically rather than narrowly.

Human request 412 represents requests from other users, for example, as part of a workflow, or as the initiation of a workflow. That is, one user may generate a request of another as part of a distributed workflow. Also, a person (e.g., a supervisor) may request that a particular type of work be accomplished, which could initiate a workflow to accomplish the work. Human request can be received via email, invitations generated from software programs, calendaring, generating a task, etc.

Business event 414 represents any type of occurrence that may take place in a business environment. Examples may include a workflow action that is generated as a result of work completed on a production line, an action generated in response to an online order being placed, etc. Business event 414 may trigger a particular business scenario that generates a workflow, or may provide context that is used in generating a workflow.

Self-initiated event 416 represents an action or a task generated by a user him- or herself. Self-initiated event 416 can be the same as most or any human request 412, but rather than coming from someone else, they are generated by the user that will perform the task. That is, the user is both the requester and the performer in the RTP relationship for that action.

Exception 418 represents any of a number of exceptions that may be triggered in the flow of business. For example, a customer support call may trigger an exception when circumstances warrant providing additional service to the customer, or if the customer becomes particularly uncooperative or upset. Additional examples may include a shutdown or error occurring on the production line, or a disruption to the normal supply chain.

Task 420 represents any other type of event trigger not mentioned already. Task 420 may also be a task of a workflow that generates/triggers another task. For example, workflows move from one task to another, and the transition from one task to the next can operate as an event that triggers a new task.

Document instantiation 422 represents any workflow action or business process that is initiated as a result of the instantiation of a document. Such techniques are described in co-pending U.S. patent application Ser. No. TBD, filed concurrently herewith, and assigned to the same corporate assignee. Document instantiation 422 can operate to begin a business process or generate a task of a business process, automatically.

Event 410 triggers long running activity 430, which is an example of a complex workflow task having multiple actions 432-436 to be performed by Role 1. The performance of actions 432-436 can generate a request that links activity 430 to activity 440 of Role 2. As illustrated, R 438 can represent a request, or any other type of relationship between activity 430 and activity 440. In one embodiment, modular workflow components other than actions are represented, and relationships may be indicated that may or may not be requests to perform. Note that activity 440 represents a “simple” activity that only requires the performance of action 442. In such a case, action 442 becomes the activity, which could be represented more explicitly than as shown in FIG. 4. Activity 440 includes request 448 for activity 450 of Role 3, which is illustrated having actions 452 and 454. Any of a number of swim lanes could be illustrated, and FIG. 4 is merely representative of the general concept.

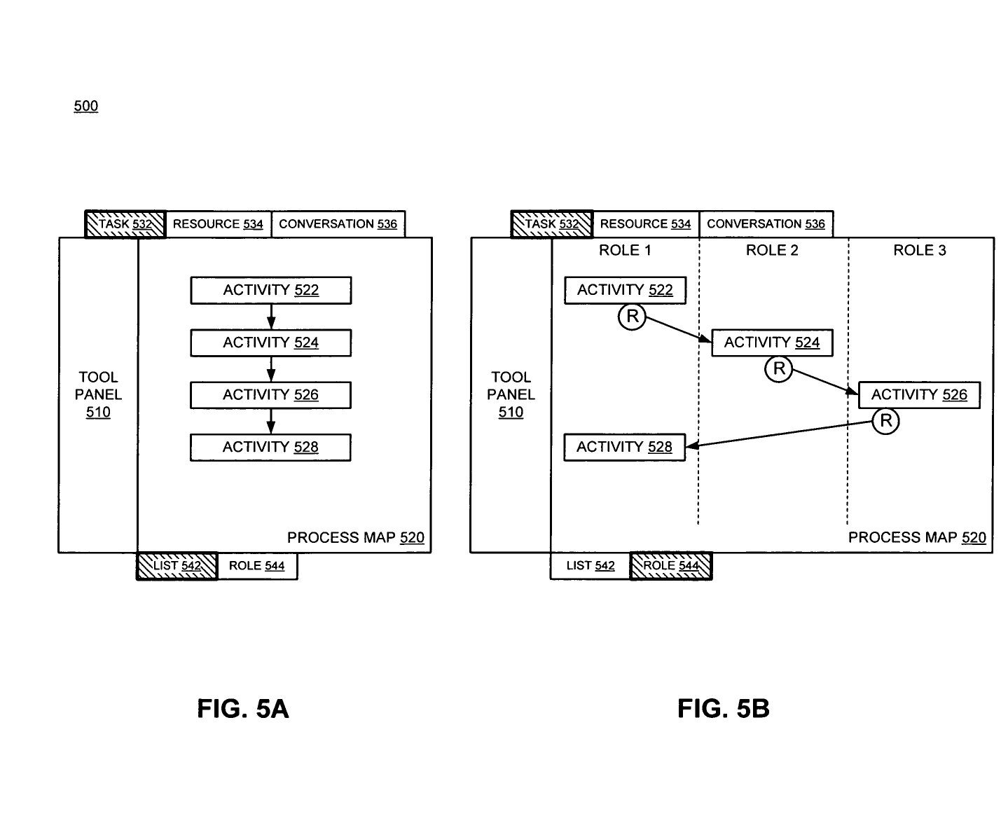

FIGS. 5A-5B are block diagrams of an embodiment of a business process development environment for developing a workflow from one of multiple management perspectives. System 500 illustrates a workflow management environment, which may be embodied in a client or application that can provide a representation of a workflow to a user. System 500 may have design-time components that define components and workflows. System 500 may also have runtime components that allow ad hoc collaboration and runtime additions to a workflow. Note that as mentioned above, a workflow may be designed in part in design-time, and completed in a more ad hoc manner with the workflow management environment described herein. Additionally, the workflow management environment can enable viewing status and interactions that take place as part of a user performing work; the interactions can be incorporated into the workflow. The workflow management environment is stored persistently in a database or other non-volatile storage device, and loaded to memory for execution. Both runtime and design-time components can be defined in storage and loaded to memory. FIG. 5A represents one management perspective of the workflow, illustrating a task layout in “list” view. FIG. 5B represents a management perspective of the same workflow, illustrating the task layout in “role” view. Tool panel 510 illustrates a toolbar or panel from which various functions can be available. Functions may be available, for example, for accessing workflow building block components, drilling down into particular components, saving a template, loading a template, etc. Note that the physical location of tool panel 510 on the representation may be in any location, and is not limited to being to the left of process map 520, or even to the side of process map 520.

In FIG. 5A, process map 520 illustrates a layout or map as provided with workflow management environment 500. Activities 522-528 represent a series of activities within a workflow. The series may be longer than what is represented. The activities may constitute a long running activity or a task of a workflow. In one embodiment, each activity includes one or more actions, which are atomic elements of work that need to be performed by different actors/performers. In list view, the traditional “process flow” can become evident as component parts of simply listed. Note that although not illustrated, process map 520 could also include information indicating the relationships between the various activities. However, the relationships may be indicated, and still not be intuitive.

In FIG. 5B, process map 520 illustrates a layout or map of the same workflow, from a different management perspective. Instead of displaying activities 522-528 in a list, activities 522-528 are mapped out according to performer, with each activity associated with a role, (Role 1, Role 2, or Role 3), as well as having a relationship defined between activities. As illustrated, activity 522 is associated with Role 1, and has relationship (e.g., an RTP relationship) with activity 524 of Role 2. Activity 524 is associated with Role 2 and has a relationship with activity 526 associated with Role 3. In turn, activity 526 may be related to activity 528 of Role 1. Any combination of activities and relationships to activities in any of the roles is possible. The views or management perspectives can be dynamically changed. Many more activities and many more roles could be involved in certain workflows.

As illustrated, workflow management environment may include particular tabs, such as the tabs at the top and bottom of process map 520. These tabs may be, for example, task 532, resource 534, conversation 536, list 542, and role 544. Not every one of the example tabs is necessary, and other tabs are possible. For convenience, and not by way of limitation, tab task 532 is highlighted in both FIGS. 5A and 5B, indicating that the view is of particular tasks or activities of a selected business process. A user could switch to resources or conversations, and any information available for those components could be illustrated. Similarly, list 542 is highlighted in FIG. 5A, and role 544 is highlighted in FIG. 5B, demonstrating the different views or information presented. Selecting one of the tabs can cause a dynamic change in what information is presented and/or how the information is presented. The layout of system 500 can be for designing, as well as modifying a workflow, such as incorporating ad hoc parts into a process.

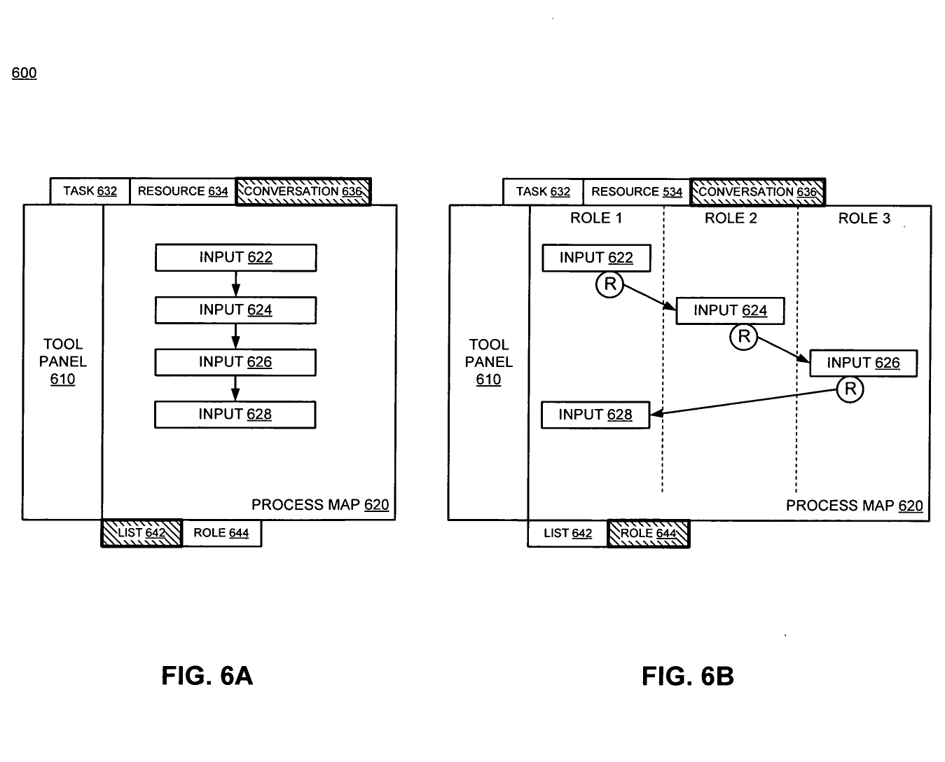

FIGS. 6A-6B are block diagrams of an embodiment of a business process development environment for developing a workflow from one of multiple management perspectives. System 600 illustrates a workflow management environment, which may be embodied in a client or application that can provide a representation of a workflow to a user. FIG. 6A represents the management perspective of a “conversation” layout of a workflow in list view. FIG. 6B represents a management perspective of a conversation layout of the same workflow in role view. As used herein, a “conversation” can refer to any interaction between people performing aspects of a workflow. For example, emails, voicemails, recordings of (verbal) collaborations or exchanges, or collaboration room interaction, etc., may all be considered conversations. Note that whereas certain aspect of business conversation related to performance of a workflow could be modeled, in other cases, layout of a conversation could be used more for purposes of review or management. Thus, conversation layout could apply to design-time in certain scenarios; however, conversation layout may be a more useful tool for a runtime engine. As for design-time, the conversation components can make up a flow that is saved in whole or in part as a template or as part of the workflow model for the current business process. The conversation components can enable data mining with the workflow management environment, by providing a record of the process and how the flow came about.

Tool panel 610 illustrates a toolbar or panel from which various functions can be available, similarly to tool panel 510 of FIG. 5. In FIG. 6A, process map 620 illustrates a layout of inputs 622-628 that are each a part of the “conversation” illustrated. Inputs 622-628 represent a series of parts of an interaction within a workflow. The series may be longer than what is represented, including many more parts than shown. In list view, what was said or done in a conversation can be recorded, and may even indicate who contributed what to the conversation.

In FIG. 6B, process map 620 illustrates a layout of the same conversation, from the different management perspective of role. Inputs 622-628 are mapped out according to performer, with each input associated with a role, (Role 1, Role 2, or Role 3), as well as having a relationship defined between inputs (where appropriate). Note that a relationship with another input may exist as a request for information or a request for a question, for example. As illustrated, input 622 is associated with Role 1, and has relationship with input 624 associated with Role 2. Input 624 has a relationship with input 626 associated with Role 3. In turn, input 626 may be related to input 628 of Role 1. Any combination of inputs and relationships associated with any of a number of roles is possible. A conversation could include many more inputs than what is illustrated.

As illustrated, workflow management environment may include particular tabs, such as the tabs at the top and bottom of process map 620. These tabs may be, for example, task 632, resource 634, conversation 636, list 642, and role 644. Not every one of the example tabs is necessary, and other tabs are possible. For convenience, and not by way of limitation, tab conversation 636 is highlighted in both FIGS. 6A and 6B, indicating that the view is of particular conversation of a selected business process. A user could switch to resources or tasks, and any information available for those components could be illustrated. Similarly, list 642 is highlighted in FIG. 6A, and role 644 is highlighted in FIG. 6B, indicating the different views or information presented. Selecting one of the tabs can cause a dynamic change in what information is presented and/or how the information is presented.

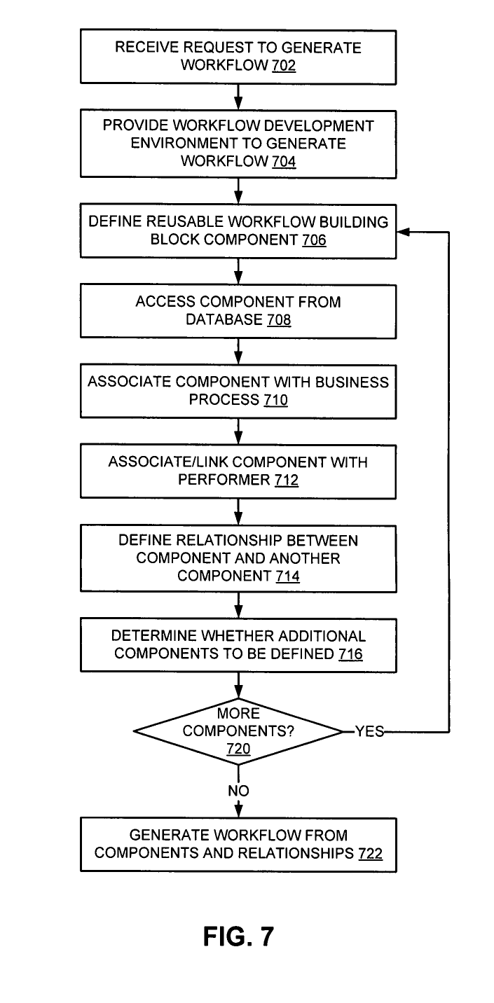

FIG. 7 is a flow diagram of an embodiment of a process for managing a business process. Managing a business process may refer to configuring a business process (e.g., creating a business process) or viewing, editing, monitoring, or otherwise accessing a business process layout. A workflow management environment as described herein enables the management of the business process. The management environment may receive a request to generate a workflow, 702. Such a workflow may be created from scratch (e.g., a new template), or may be created from a template (e.g., specific components and relationships can be generated within a model for a workflow. A workflow can be created in whole or in part. Relationships between parts of a workflow can be explicitly defined, defined in the abstract, or not defined at design-time, but left to be defined at run-time.

In one embodiment, the management environment provides a workflow development environment to generate the requested workflow, 704. If the workflow already exists and does not need to be “created,” the management environment can merely access the workflow and present it to the requesting user. Creating the workflow can be considered to be creating an instance of the workflow. In one embodiment, the workflow is composed of multiple reusable workflow building block components, which are generated or defined to create the workflow. Thus, the system defines a reusable workflow building block component, 706. Note that the component may or may not already be “defined” in the sense that it exists within the backend system as a component that can be placed in a workflow. In the case that the component does not already exist, it can be created in the development environment. In case it does exist, defining the component can refer to accessing and placing the component in the workflow to be viewed.

The system can access the component from a backend database if the component exists, 708. The component is associated with the business process for which the workflow is to be created, 710. Note that the component may already be associated with the business process via a defined relationship that exists with a component template. The component is also associated/linked with a performer, 712. The performer is the entity that will perform an action, or use a business resource.

The system also defines a relationship between the component and another component, 714. Such a relationship may be an RTP relationship, or another relationship appropriate to link one component with another. A workflow will generally have multiple resources to define for multiple different tasks of the workflow. Thus, the same acts of defining and relating resources to performers and other resources can continue until the entire workflow is generated. Thus, the system determines whether additional components are to be defined, 716. If there are more components to define, 720, the process repeats, beginning with defining the next component, 706. If there are no more components to be defined (the workflow is complete), 720, the system generates the workflow from the components and relationships as defined, 722.

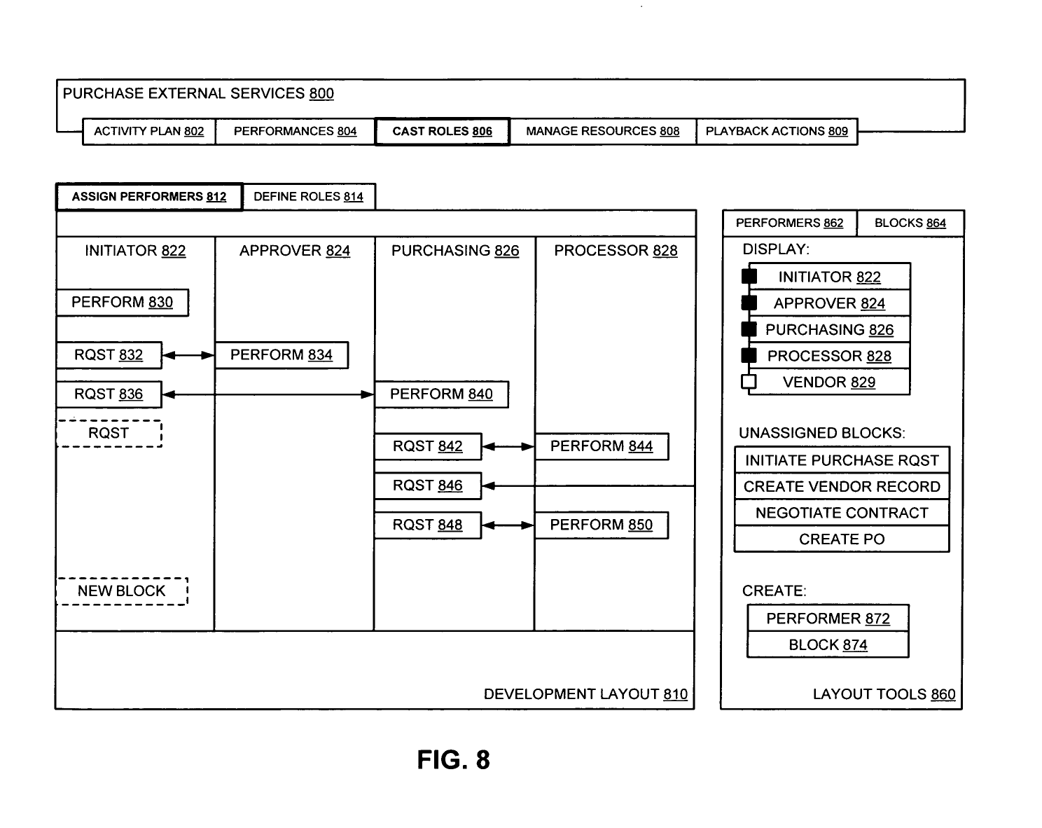

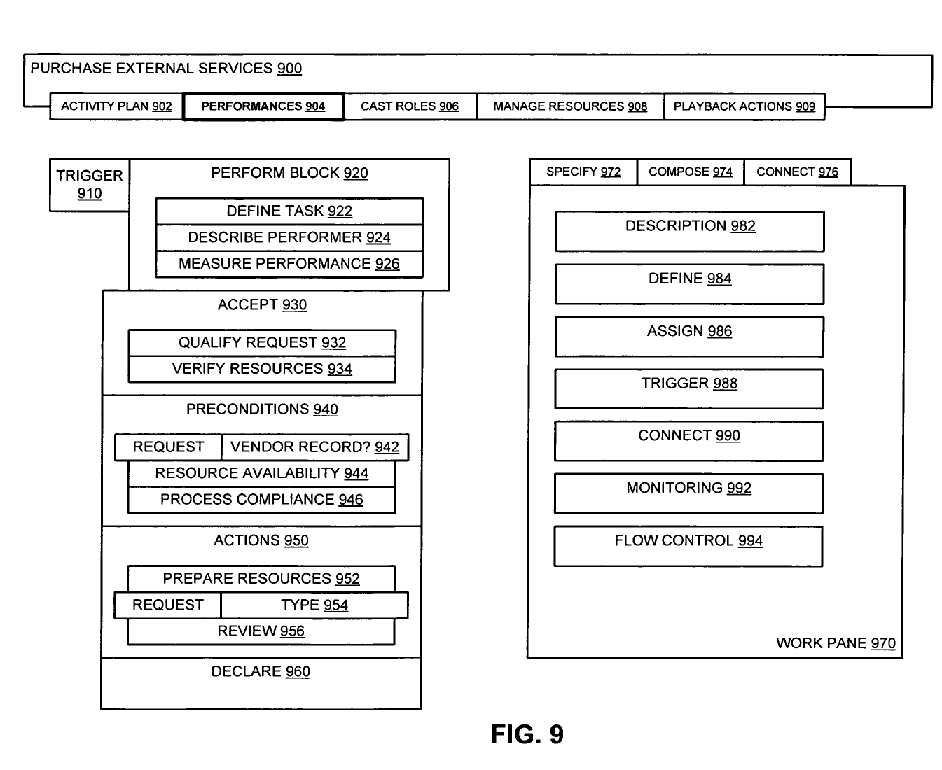

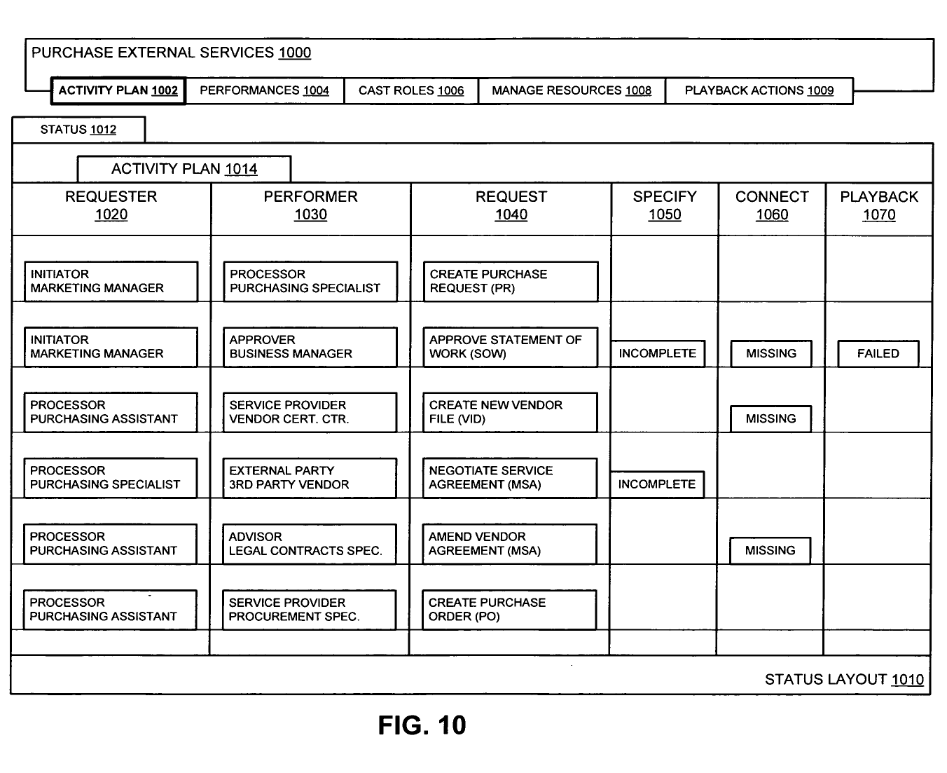

FIG. 8 is a block diagram of an embodiment of a business scenario modeler. Business scenario 800 is a purchase of external services. A workflow management environment can include functionality that is able to define a workflow for the purchase of external services according to any of a number of views that allows modeling in any of a number of different levels. In one embodiment, the business scenario modeler represents functionality of a workflow management environment for modeling on a business scenario layer. The business scenario modeler may be represented by tab 806, cast roles, which enables a developer to define roles, activities, and relationships between roles. Other possible views allowing modeling on other possible layers can be activity plan tab 802 (see FIG. 10), performances tab 804 (see FIG. 9), manage resources tab 808 for defining and managing resources, and playback actions tab 809 for reviewing and data mining of completed actions.

Development layout 810 represents a pane or work area for the business scenario modeler to show swim lane layout of key performers. In one embodiment, initiator 822, approver 824, purchasing 826, and processor 828 are key performers for the purchase external services business process. Other performers may be part of the process and not shown, or not currently shown on the screen.

Note that development layout 810 includes multiple potential views, for example, assign performers 812, and define roles 814. Switching between the layout views may change the layout of the screen, and may change the tools available, as will be appreciated by the skilled practitioner. Assign performer 812 allows the business scenario modeler to define who will participate in the workflow, and can be defined by role (shown), skill, or by name. Define roles 814 can allow defining a workflow via role, and then providing skill or name definitions to the selected roles. In one embodiment, roles as available within the enterprise backend system are used.

Initiator 822 is shown with perform block 830, which represents some action or work that needs to be performed. Also illustrated in the swim lane of initiator 822 is request (rqst) 832 and request 836. These requests trigger an activity for another performer. For example, request 832 triggers perform block 834, which represents an activity to be performed by approver 824. Request 836 triggers perform block 840 for purchasing 826. The activities are related with the RTP relationships, and the activities are associated with the performer in whose swim lane they are found.

In one embodiment, triggering an activity for one performer may trigger a long running activity that generates other requests from that performer to other performers. As illustrated, perform block 840 of purchasing 826 may generate request 842 that triggers perform block 844 of processor 828, and request 848 that triggers perform block 850 of processor 828. Request 846 of purchasing 826 is related to an activity that is “off screen” with respect to the view of development layout 810 of FIG. 8. It may trigger an activity for a performer not currently shown, or it could trigger an ad hoc activity that is not yet defined. Each perform block may be defined specifically in terms of the actions required to complete it, or alternatively one or more may be partially defined.

Layout tools 860 represent functions that can facilitate the development of the workflow being generated in development layout 810. In one embodiment, layout tools 860 includes different tabs to switch to different tool sets, for example, performers 862 and block 864. For purposes of simplicity, functional tools from both tabs are displayed in layout tools 860, and such access to design tools is an implementation choice. As illustrated, layout tools 860 may indicate performers who are and who are not (currently) displayed. If a performer is not displayed, it could be that the performer has not yet been added to the model, or it could be that development layout 810 needs to be “scrolled” to the right or left to display the missing performer. For example, initiator 822, approver 824, purchasing 826, and processor 828 are all displayed, but vendor 829 is not. As an example, request 846 may trigger an activity for vendor 829, that is not visible without scrolling right, or adding the vendor swim lane to the layout.

Block tools may include unassigned blocks, such as initiate purchase request, create vendor record, negotiate contract with vendor, create PO (purchase order), etc. In one embodiment, system context enables the workflow management environment to present only blocks that are relevant to the particular business scenario. Other block may exist within the system that would be displayed under other scenarios. In one embodiment, unassigned blocks are blocks that are necessary to complete the workflow for the business scenario of purchase external services, but have not yet been assigned in the model. Note that initiator 822 include a dashed box for a new request and a dashed box for a new block (a new perform block as selected from unassigned blocks). The new block or the new request could also be placed under other performers.

In one embodiment, layout tools 860 also includes tools to create new performer 872, or create new block 874, which can enable a developer or user to define new components to include within the workflow.

FIG. 9 is a block diagram of an embodiment of an activity modeler. A workflow management environment has business scenario 900 of purchase of external services. The workflow management environment can include functionality to define perform blocks of a workflow. Performances tab 904 may be selected to define the various perform blocks, such as those seen in FIG. 8. Each perform block is triggered, as illustrated by trigger 910. Triggers are events, as described above, that initiate an action or an activity (represented with perform blocks). The activity modeler is represented by selected tab performances tab 904.

Perform block 920 represents any type of perform block that may be assigned to a performer in a workflow layout. Perform block 920 is represented with define task 922, describe performer 924, and measure performance 926. Other related blocks could be part of the definition of perform block 920. Define task 922 enables a developer to provide a definition of the task, which might label the task, its purpose, and what will be performed. Describe performer 924 provides a definition or assignment of who will perform the task, such as the skill or position required to perform the task. Measure performance 926 allows performance parameters become part of the model to know what performance is expected, and have a measure of how performance actually matched with expectations.

As described above, the process of event (trigger), accept, perform, and output may be one model for a distributed activity. Similarly, each perform block 920 may have accept block 930 to define acceptance of a triggered task/activity, preconditions block 940 to define the state necessary to perform the actions of the task, actions 950 that define what work is required to complete the task, and declare 960 that define the output of the task.

Accept block 930 may include, for example, qualify request 932 and verify resources 934. Qualify request 932 enables a requested performer to request additional information, additional resources, clarification, etc., on the task to be able to complete it. Verify resources 934 enables the user or the system to check the validity (e.g., digital signatures, etc.) of resources, or make sure that the performer has the proper credential necessary to access necessary resources.

Preconditions 940 enable the user or the system to make sure all resources and conditions necessary for the performance of the task are complete. For example, if a task is to request a part from a certain vendor, a necessary precondition for requesting the part is to make sure the vendor exists within the system. Thus, there may be a request to determine whether there is a vendor record 942. Additionally, resource availability 944 can enable the user or system to verify that the key resources are available, or check-out the resources or otherwise schedule necessary resource use. Process compliance 946 is an example of determining whether proper laws or safety procedures are being followed, as appropriate to the requested task.

Actions 950 define the actual work to be done. Work can range from preparing resources 952 to making a request of some type 954, or reviewing a document or resource 956. Finally, as mentioned above, declare 960 provides an output to the system and/or to a user to represent the results of the work performed in actions 950.

Work pane 970 can provide various tools or functions that can be useful or necessary to define or model one or more aspects of the activity. Different classes of tools may be available, such as shown by specify 972 (tools to define or specify aspects of a block), compose 974 (tools to generate the modeled/defined activity), and connect 976 (tools to define relationships or requests). Examples of various tools may include description 982, define 984, assign 986, trigger 988, connect 990, monitoring 992, and flow control 994.

Description 982 may provide a system-level description of a block or a part of a block, or provide explanation as to what parameters or input is needed to model something. Define 984 can provide input boxes, selection lists, check boxes, parameter lists, etc., to define a request, an action, or some resource, or any of the blocks shown to the left of work pane 970. Assign 986 provides tools to assign relationships between actions and performers, resources and scenarios, etc. Such assignments can be made via input boxes, selection lists, side-by-side pull-down lists, etc.

Trigger 988 allows the defining of triggers for perform blocks, and the describing of the conditions for the triggered performance. Connect 990 describes connections to resources and may be assigned in much the same manner as assign 986. Monitoring 992 enables the setting of conditions for monitoring the performance, how the performance will be monitored, by whom, who will receive notifications or can view the workflow, etc. Flow control 994 enables defining the state changes from one block to another. That is, system action after a particular block has been performed can be prescribed, and ownership (and/or responsibility) can be defined for activities.

FIG. 10 is a block diagram of an embodiment of project status monitoring. Project monitoring status may be selected for the workflow management environment via tab activity plan 1002 for business scenario purchase external services 1000. In one embodiment, selecting tab 1002 brings up status layout 1010, which is a status window 1012. Within status layout 1010, activity plan 1014 can be shown in list or tabular view for each element of the workflow. All or some of the activities can be shown. In one embodiment, status layout 1010 includes views for requester 1020, performer 1030, request 1040, specify (status) 1050, connect 1060, and playback 1070.

In the example illustrated, requester 1020 shows a requester type with a role type. For example, the first block on the list is the marketing manager as initiator of a workflow. Other blocks show a purchasing specialist as a processor. Each requester 1020 has an associated performer 1030. As illustrated, the marketing manager as initiator makes a request of purchasing specialist as a processor for a request 1040 to create a purchase request (PR). The other relationship are similar: a requester (1020) is associated with a performer (1030) via a request (1040). The specific status of each relationship can be shown in specify 1050. For example, the marketing manager request as initiator to the business manager as approver to approve the statement of work (SOW), is specified as incomplete. Furthermore, as illustrated, a connection to a resource is either missing or does not exist. Playback of the activity might be attempted and failed due to the missing resource. Other layouts are possible that can show the same and/or different information. Importantly, the status layout allows a view of various parts of a workflow, and their relationships.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for presenting a business process, comprising:
providing a visual workflow management environment having multiple different views that represent different workflow management perspectives, the environment having multiple separate sections, each separate section representing a separate performer;
defining a first reusable workflow component associated with the business process;
associating the first component with a first performer in a corresponding section of the environment;
defining a second reusable workflow component associated with the business process;
associating the second component with a second performer in a corresponding section of the environment;
defining a relationship between the first and second components to create a portion of a workflow for the business process.

2. The method of claim 1, wherein the different views comprise a list view and a swim lane view.

3. The method of claim 1, wherein the different management perspectives comprise management of actions, resources, and conversations.

4. The method of claim 3, wherein the actions comprise atomic enterprise business work activities.

5. The method of claim 3, wherein the resources comprise a resource provided via a unified resource model.

6. The method of claim 3, wherein the resources comprise one or more of a business object, a document, a file, or an enterprise service.

7. The method of claim 3, wherein the conversations comprise human-to-human interaction as part of accomplishing the workflow.

8. The method of claim 7, wherein the human-to-human interactions include recorded verbal exchanges.

9. The method of claim 1, wherein defining the relationship between the first and second components comprises:
defining a request-to-perform relationship.

10. The method of claim 1, further comprising:
dynamically switching from the management environment having multiple separate sections in a swim lane view to a list view having all resources listed and not visually associated with performers.

11. The method of claim 1, further comprising:
dynamically switching to a different management perspective by selecting a different resource type to manage.

12. An article of manufacture comprising a machine readable medium having content stored thereon to provide instructions to cause a machine to perform operations for presenting a business process, including:
providing a visual workflow management environment having multiple different views that represent different workflow management perspectives, the environment having multiple separate sections, each separate section representing a separate performer;
defining a first reusable workflow component associated with the business process;
associating the first component with a first performer in a corresponding section of the environment;
defining a second reusable workflow component associated with the business process;
associating the second component with a second performer in a corresponding section of the environment;
defining a relationship between the first and second components to create a portion of a workflow for the business process.

13. The article of manufacture of claim 12, wherein the different views comprise a list view and a swim lane view.

14. The article of manufacture of claim 12, wherein the different management perspectives comprise management of actions, resources, and conversations.

15. The article of manufacture of claim 12, the content to further provide instructions to cause the machine to perform operations including:
dynamically switching from the management environment having multiple separate sections in a swim lane view to a list view having all resources listed and not visually associated with performers.

16. The article of manufacture of claim 12, the content to further provide instructions to cause the machine to perform operations including:
dynamically switching to a different management perspective by selecting a different resource type to manage.

17. A system comprising:
a database having reusable building block components with which to generate a workflow to execute a business process;
a memory coupled to the database, the memory to be loaded with reusable building block components from the database; and
a process map designer loaded in the memory to represent different workflow management perspectives with different views of the reusable building block components, process map designer having multiple separate sections, each separate section representing a separate performer, the process map designer to define first and second reusable workflow components associated with the business process, associate the first component with a first performer in a corresponding section of the process map designer, associate the second component with a second performer in a corresponding section of the process map designer, and define a relationship between the first and second components to create a portion of a workflow for the business process.

18. The system of claim 17, the process map designer to further:
dynamically switch from the management environment having multiple separate sections in a swim lane view to a list view having all resources listed and not visually associated with performers.

19. The system of claim 17, the process map designer to further:
dynamically switch to a different management perspective by selecting a different resource type to manage.

20. The system of claim 17, further comprising:
a context determiner coupled to the process map designer, to determine a business context of the business process, and indicate the business context to the process map designer.
